(19) United States
(12) Patent Application Publication
(10) Pub. No.: US 2025/0066564 A1
(43) Pub. Date: Feb. 27, 2025

(54) A PROCESS TO IMPROVE THE UTILITY OF RECYCLED POLYPROPYLENE

(71) Applicant: SABIC GLOBAL TECHNOLOGIES B.V., Bergen op Zoom (NL)

(72) Inventors: Ginger DE LA CROIX, Hoensbroek (NL); Dimphna Johanna, Maria VAN BEEK, Sittard (NL); Liang WEN, Shanghai (CN); Jing GUO, Shanghai (CN); Ting HUANG, Shanghai (CN); Kevin DI, Shanghai (CN); Chaodong JIANG, Shanghai (CN)

(21) Appl. No.: 18/724,754

(22) PCT Filed: Dec. 16, 2022
(86) PCT No.: PCT/EP2022/086273

§ 371 Date: Jun. 27, 2024

(30) Foreign Application Priority Data
Dec. 31, 2021 (WO) PCT/CN2021/143657

(51) Int. Cl. C08J 5/08; C08J 3/12; C08J 3/22; C08L 23/12

(52) U.S. Cl. CPC C08J 5/08; C08J 3/12; C08J 3/22; C08L 23/12; C08J 2323/12; C08J 2423/12; C08L 2205/025

(57) ABSTRACT

A process for the preparation of a glass fiber reinforced composition containing a recycled polypropylene includes a) unwinding from a package the continuous glass multifilament strands, b) applying an impregnating agent to the continuous glass multifilament strands to form the impregnated continuous multifilament strands and c) applying the sheath of a first polymer composition around the impregnated continuous multifilament strands to form the sheathed continuous multifilament strands, d) pelletizing the sheathed continuous multifilament strands to form pellets of the sheathed multifilament strands, e) homogenizing the pellets of the sheathed multifilament strands with a second polymer composition, wherein the first polymer composition comprises at least 80 wt % of a recycled polypropylene (PP1), and the second polymer composition includes at least 80 wt % of a second polypropylene (PP2), wherein the MFI of the PP1 and PP2 satisfy the following equation: 0.2≤MF_{IPP1}/MF_{IPP2}≤1.2.

### CROSS REFERENCE TO RELATED APPLICATIONS

This application is a National Stage application of PCT/EP2022/086273, filed Dec. 16, 2022, which claims the benefit of International Application No. PCT/CN2021/143657, filed Dec. 31, 2021, both of which are incorporated by reference in their entirety herein.

### BACKGROUND

The present invention relates to a process for the preparation of a glass fiber reinforced composition wherein the glass fiber reinforced composition comprises a recycled polypropylene. The present invention further relates to a glass fiber reinforced composition obtained by the said process.

The process for recycling polypropylene is known in the art, e.g. WO2012117250, U.S. Pat. No. 9,670,344 and WO2014040634. But the recycled polypropylene typically suffers degradation of mechanical properties e.g. tensile modulus comparing to virgin polypropylene. One typical solution to this issue is diluting the recycled polypropylene in a virgin polypropylene to obtain a polypropylene blend, However the polypropylene blend also typically suffers from the degradation of recycled polypropylene.

Therefore there is a need in the industry to improve the utility of recycled polypropylene, e.g. having a process employing recycled polypropylene without compromise on mechanical properties, e.g. tensile modulus.

### SUMMARY

This need is satisfied by a process for the preparation of a glass fiber reinforced composition comprising the sequential steps of:
a) unwinding from a package the continuous glass multifilament strands,
b) applying an impregnating agent to the continuous glass multifilament strands to form the impregnated continuous multifilament strands and
c) applying the sheath of a first polymer composition around the impregnated continuous multifilament strands to form the sheathed continuous multifilament strands,
d) pelletizing the sheathed continuous multifilament strands to form pellets of the sheathed multifilament strands,
e) homogenizing the pellets of the sheathed multifilament strands with a second polymer composition,
wherein the first polymer composition comprises a recycled polypropylene (PP1), wherein the amount of the recycled polypropylene (PP1) is at least 80 wt % based on the total amount of the first polymer composition,
wherein the second polymer composition comprises a second polypropylene (PP2), wherein the amount of the second polypropylene (PP2) is at least 80 wt % based on the total amount of the second polymer composition,
wherein the melt flow index (MFI) of the recycled polypropylene (PP1) and of the second polypropylene (PP2) satisfy the following equation:

$$0.2 \leq {MFI}_{PP 1} / {MFI}_{PP 2} \leq 1.2$$

wherein MF_{IPP1} is the MFI of the recycled polypropylene (PP1) as measured according to ISO1133-1:2011 at 230°, 2.16 kg, wherein MF_{IPP2} is the MFI of the second polypropylene (PP2) as measured according to ISO1133-1:2011 at 230°, 2.16 kg.

### DETAILED DESCRIPTION

It was surprisingly found by the inventors of the present invention that the process according to the invention could improve the utility of the recycled polypropylene from the sense that no degradation of tensile modulus is observed.

Steps a), b) are described in detail in WO2009/080281A1, which document is hereby incorporated by reference. Step c) is also disclosed in WO2009/080281A1 except for the first polymer composition.

Preferably step b) is carried out in a first extruder. It is preferred that the impregnating agent is fed in the first extruder, wherein the continuous glass multifilament strands are drawn through the barrel of the first extruder through the die positioned on the side of the barrel.

Preferably step c) is carried out in a second extruder. It is preferred that the first polymer composition is fed in the second extruder, wherein the impregnated continuous multifilament strands are drawn through the barrel of the second extruder through the dies positioned on the side of the barrel.

Preferably in the sheathed continuous multifilament strands obtained in step c) the impregnating agent intimately surrounds the continuous glass multifilament strands, the sheath of the first polymer composition intimately surrounds the impregnated continuous multifilament strands.

The term intimately surrounding as used herein is to be understood as meaning that the impregnating agent substantially entirely contacts the continuous glass multifilament strands, the sheath of the first polymer composition substantially entirely contacts the impregnated continuous multifilament strands.

Said in another way the sheath of the first polymer composition is applied in such a manner onto the impregnated continuous mutifilament strands that there is no deliberate gap between an inner surface of the sheath of the first polymer composition and the impregnated continuous mutifilament strands. A skilled person will nevertheless understand that a certain small gap between the sheath of the first polymer composition and the impregnated continuous mutifilament strands may be formed as a result of process variations. Preferably, therefore, the sheath of the first polymer composition comprises less than 5 wt. % of said filament, preferably less than 2 wt. % of filament based on the total weight of the polymer sheath.

Preferably step d) comprises two sequential steps:
d1) cooling the sheathed continuous multifilament strands, e.g. by air blade or water bath preferably using water bath,
d2) cutting the cooled sheathed continuous multifilament strands into pellets of sheathed multifilament strands. The pellets of sheathed multifilament strands are typically in cylindrical form, wherein the pellets have length in the range from 4 to 25 mm, preferably from 10 to 20 mm.

Preferably step e) is carried out by dry blending the pellets of the sheathed multifilament strands with the second polymer composition or by melt mixing the pellets of the sheathed multifilament strands with the second polymer composition. Dry blending is to be understood as mixing of pellets without the need of any heating; melt mixing requires heating to melt the pellet for further mixing.

More preferably, step e) is carried out by dry blending the pellets of the sheathed multifilament strands with the second polymer composition.

The impregnated continuous multifilament strand is prepared from a continuous glass multifilament strand and an impregnating agent.

Glass fibres are generally supplied as a plurality of continuous, very long filaments, and can be in the form of strands, rovings or yarns. A filament is an individual fibre of reinforcing material. A strand is a plurality of bundled filaments. Yarns are collections of strands, for example strands twisted together. A roving refers to a collection of strands wound into a package.

For purpose of the invention, a glass multifilament strand is defined as a plurality of bundled glass filaments.

Glass multifilament strands and their preparation are known in the art.

The filament density of the continuous glass multifilament strand may vary within wide limits. For example, the continuous glass multifilament strand may have at least 500, for example at least 1000 glass filaments/strand and/or at most 10000, for example at most 5000 grams per 1000 meter. Preferably, the amount of glass filaments/strands is in the range from 500 to 10000 grams per 1000 meterglass filaments/strand.

The thickness of the glass filaments is preferably in the range from 5 to 50 μm, more preferably from 10 to 30 μm, even more preferably from 15 to 25 μm. Usually the glass filaments are circular in cross section meaning the thickness as defined above would mean diameter. The glass filaments are generally circular in cross section.

The length of the glass filaments is in principle not limited as it is substantially equal to the length of the sheathed continuous multifilament strand. For practical reasons of being able to handle the tape however, it may be necessary to cut the sheathed continuous multifilament strand into a shorter strand. For example the length of the sheathed continuous multifilament strand is at least 1 m, for example at least 10 m, for example at least 50 m, for example at least 100 m, for example at least 250 m, for example at least 500 m and/or for example at most 25 km, for example at most 10 km.

Preferably, the continuous glass multifilament strand in the tape of the invention comprises at most 2 wt %, preferably in the range from 0.10 to 1 wt % of a sizing based on the continuous glass multifilament strand. The amount of sizing can be determined using ISO 1887:2014.

A sizing composition is typically applied to the glass filaments before the glass filaments are bundled into a continuous glass multifilament strand.

Suitable examples of sizing compositions include solvent-based compositions, such as an organic material dissolved in aqueous solutions or dispersed in water and melt- or radiation cure-based compositions. Preferably, the sizing composition is an aqueous sizing composition.

As described in the art, e.g. in documents EP1460166A1, EP0206189A1 or U.S. Pat. No. 4,338,233, the aqueous sizing composition may include film formers, coupling agents and other additional components.

The film formers are generally present in effective amount to protect fibres from interfilament abrasion and to provide integrity and processability for fibre strands after they are dried. Suitable film formers are miscible with the polymer to be reinforced. For example; for reinforcing polypropylenes, suitable film formers generally comprise polyolefin waxes.

The coupling agents are generally used to improve the adhesion between the matrix thermoplastic polymer and the fibre reinforcements. Suitable examples of coupling agents known in the art as being used for the glass fibres include organofunctional silanes. More particularly, the coupling agent which has been added to the sizing composition is an aminosilane, such as aminomethyl-trimethoxysilane, N-(beta-aminoethyl)-gamma-aminopropyl-trimethoxysilane, gamma-aminopropyl-trimethoxysilane gamma-methylaminopropyl-trimethoxysilane, delta-aminobutyl-triethoxysilane, 1,4-aminophenyl-trimethoxysilane. Preferably, in the tape of the invention, the sizing composition contains an aminosilane to enable a good adhesion to the thermoplastic matrix. The sizing composition may further comprise any other additional components known to the person skilled in the art to be suitable for sizing compositions. Suitable examples include but are not limited to lubricants (used to prevent damage to the strands by abrasion) antistatic agents, crosslinking agents, plasticizers, surfactants, nucleation agents, antioxidants, pigments as well as mixtures thereof.

Typically, after applying the sizing composition to the glass filaments, the filaments are bundled into the continuous glass multifilament strands and then wound onto bobbins to form a package.

In the present invention, the impregnated continuous multifilament strand is prepared from a continuous glass multifilament strand and an impregnating agent and in particular by applying an impregnating agent to the continuous glass multifilament strand preferably in an amount from 0.50 to 18.0 wt %, for example from 0.5 to 10.0 wt % or for example from 10.0 to 18.0 wt % based on the sheathed continuous multifilament strands.

The optimal amount of impregnating agent applied to the continuous glass multifilament strand depends on the sheath of the first polymer composition, on the size (diameter) of the glass filaments forming the continuous glass strand, and on the type of sizing composition. Typically, the amount of impregnating agent applied to the continuous glass multifilament strand is for example at least 0.50 wt %, preferably at least 1.0 wt %, preferably at least 1.5 wt %, preferably at least 2 wt %, preferably at least 2.5 wt % and/or at most 10.0 wt %, preferably at most 9.0 wt %, more preferably at most 8.0 wt %, even more preferably at most 7.0 wt %, even more preferably at most 6.0 wt %, even more preferably at most 5.5 wt %, or for example at least 10.0 wt %, preferably at least 11 wt %, preferably at least 12 wt % and/or at most 18 wt %, preferably at most 16 wt %, preferably at most 14% based on the amount of sheathed continuous multifilament strands. Preferably, the amount of impregnating agent is in the range from 1.5 to 8 wt %, even more preferably in the range from 2.5 wt % to 6.0 wt % based on the sheathed continuous multifilament strand. A higher amount of impregnating agent increases the Impact Energy per unit of thickness (J/mm). However, for reasons of cost-effectiveness and low emissions (volatile organic compounds) and mechanical properties, the amount of impregnating agent should also not become too high.

For example, the ratio of impregnating agent to continuous glass multifilament strand is in the range from 1:4 to 1:30, preferably in the range from 1:5 to 1:20.

Preferably, the viscosity of the impregnating agent is in the range from 2.5 to 200 cSt at 160° C., more preferably at least 5.0 cSt, more preferably at least 7.0 cSt and/or at most 150.0 cSt, preferably at most 125.0 cSt, preferably at most 100.0 cSt at 160° C.

An impregnating agent having a viscosity higher than 100 cSt is difficult to apply to the continuous glass multifilament strand. Low viscosity is needed to facilitate good wetting performance of the fibres, but an impregnating agent having a viscosity lower than 2.5 cSt is difficult to handle, e.g., the amount to be applied is difficult to control; and the impregnating agent could become volatile. For purpose of the invention, unless otherwise stated, the viscosity of the impregnating agent is measured in accordance with ASTM D 3236-15 (standard test method for apparent viscosity of hot melt adhesives and coating materials, Brookfield viscometer Model RVDV 2, #27 spindle, 5 r/min) at 160° C.

Preferably, the melting point of (that is the lowest melting temperature in a melting temperature range) the impregnating agent is at least 20° C. below the melting point of the first polymer composition. More preferably, the impregnating agent has a melting point of at least 25 or 30° C. below the melting point of the first polymer composition. For instance, when the first polymer composition has a melting point of about 160° C., the melting point of the impregnating agent may be at most about 140° C.

Suitable impregnating agents are compatible with the thermoplastic polymer to be reinforced, and may even be soluble in said polymer. The skilled man can select suitable combinations based on general knowledge, and may also find such combinations in the art.

The impregnating agent preferably comprises highly branched poly(alpha-olefins), such as highly branched polyethylenes, modified low molecular weight polypropylenes, mineral oils, such as, paraffin or silicon and any mixtures of these compounds.

The impregnating agent preferably comprises at least 20 wt %, more preferably at least 30 wt %, more preferably at least 50 wt %, for example at least 99.5 wt %, for example 100 wt % of a branched poly(alpha-olefin), most preferably a branched polyethylene.

To allow the impregnating agent to reach a viscosity of from 2.5 to 200 cSt at 160° C., the branched poly(alpha-olefin) may be mixed with an oil, wherein the oil is chosen from the group consisting of mineral oils, such as a paraffin oil or silicon oil; hydrocarbon oils; and any mixtures thereof.

Preferably, the impregnating agent is non-volatile, and/or substantially solvent-free. In the context of the present invention, non-volatile means that the impregnating agent has a boiling point or range higher than the temperatures at which the impregnating agent is applied to the continuous multifilament glass strand. In the context of present invention, “substantially solvent-free” means that impregnating agent contains less than 10 wt % of solvent, preferably less than 5 wt % of solvent based on the impregnating agent. In a preferred embodiment, the impregnating agent does not contain any organic solvent.

The impregnating agent may further be mixed with other additives known in the art. Suitable examples include lubricants; antistatic agents; UV stabilizers; plasticizers; surfactants; nucleation agents; antioxidants; pigments; dyes; and adhesion promoters, such as a modified polypropylene having maleated reactive groups; and any combinations thereof, provided the viscosity remains within the desired range. Any method known in the art may be used for applying the liquid impregnating agent to the continuous glass multifilament strand. The application of the liquid impregnating agent may be performed using a die. Other suitable methods for applying the impregnating agent to the continuous multifilament strands include applicators having belts, rollers, and hot melt applicators. Such methods are for example described in documents EP0921919B1, EP0994978B1, EP0397505B1, WO2014/053590A1 and references cited therein. The method used should enable application of a constant amount of impregnating agent to the continuous multifilament strand.

Preferably the amount of glass multifilament strands is in the range from 15 to 50 wt %, more preferably from 17 to 35 wt %, more preferably from 18 to 25 wt % based on the total amount of glass fiber reinforced composition obtained in step e).

### Sheath of the First Polymer Composition

Preferably, the thickness of the sheath of the first polymer composition in the sheathed continuous multifilament strand is between 200 and 1500 micrometer, for example 500 and 1500 micrometer.

Preferably the amount of first polymer composition is in the range from 6 to 35 wt %, more preferably from 8 to 25 wt %, more preferably from 9 to 16 wt % based on the total amount of glass fiber reinforced composition obtained in step e).

The first polymer composition comprises a recycled polypropylene (PP1), wherein the amount of the recycled polypropylene (PP1) is at least 80 wt %, preferably at least 90 wt %, preferably at least 94 wt % based on the total amount of the first polymer composition,

The recycled polypropylene (PP1) used in the present invention is obtained by processing a waste plastic material derived from post-consumer and/or post-industrial waste, preferably derived from post-industrial waste, by known methods involving e.g. washing, sorting and/or grinding.

The recycled polypropylene (PP1) preferably comprises a propylene-based polymer at an amount of at least 90 wt % with respect to the recycled composition. Herein, a propylene-based polymer is understood as a propylene homopolymer, a propylene copolymer including random copolymers and (multi) block copolymers or a heterophasic propylene copolymer, having propylene monomer units at an amount of at least 50 wt %, for example at least 80 wt %.

The recycled polypropylene (PP1) preferably has an ash residue of lower than 5.0 wt %, preferably lower than 3.0 wt %, more preferable lower than 2.0 wt % as measured according to ISO 3451-1:2019 at 550° C. based on the total amount of the recycled polypropylene (PP1). The low ash content may lead to a better aesthetical quality and allow better control of the amount of the inorganic material in the blended composition of the invention. Without wishing to be bound to any theory, the ash residue in recycled polypropylene (PP1) is preferably at least 0.5 wt %, more preferably at least 1.0 wt % so that a complex crystallization could take place to improve the stiffness of the glass fiber reinforced composition obtained in step e).

Preferably the MFI of the recycled polypropylene (PP1) is in the range from 15 to 60 g/10 min, preferably from 18 to 45 g/10 min, more preferably from 19 to 30 g/10 min as measured according to ISO1133-1:2011 at 230°, 2.16 kg.

Preferably the tensile modulus of the recycled polypropylene (PP1) is in the range from 1050 to 1800 MPa, preferably from 1100 to 1570 MPa, more preferably from 1125 to 1325 MPa as measured according to ISO527-1:2019 using 1A specimen.

The first polymer composition according to the present invention may further contain additives, for instance nucleating agents and clarifiers, stabilizers, release agents, plasticizers, antioxidants, lubricants, anti-statics, cross linking agents, scratch resistance agents, high performance fillers, pigments and/or colorants, flame retardants, blowing agents, acid scavengers, recycling additives, anti-microbials, anti-fogging additives, slip additives, anti-blocking additives, polymer processing aids and the like. Such additives are well known in the art. The total amount of the recycled polypropylene (PP1) and the additives is preferably at least 95 wt %, more preferably at least 98 wt % based on the total amount of the first polymer composition.

### The Second Polymer Composition

The second polymer composition comprises a second polypropylene (PP2), wherein the amount of the second polypropylene (PP2) is at least 80 wt %, preferably at least 90 wt %, more preferably at least 95 wt %, even more preferably at least 98 wt % based on the total amount of the second polymer composition.

The second polymer composition is preferably provided in pellet form in step e).

The amount of the second polymer composition is preferably in the range from 30 to 80 wt %, preferably from 40 to 75 wt %, more preferably from 50 to 72 wt % based on the total amount of the of the glass fiber reinforced composition obtained in step e).

The second polypropylene (PP2) is preferably a virgin polypropylene, wherein “virgin” is to be understood as second polypropylene (PP2) has not been shaped or used prior to being employed in step e).

The second polypropylene (PP2) is preferably a heterophasic polypropylene comprising a propylene homopolymer as matrix and an ethylene-α-olefin copolymer as dispersed phase, wherein the amount of the propylene homopolymer is preferably in the range from 74 to 88 wt %, more preferably from 80 to 87 wt % based on the total amount of the heterophasic polypropylene. The total amount of the propylene homopolymer and the ethylene-α-olefin copolymer is preferably at least 95 wt %, more preferably at least 98 wt %, even more preferably at least 95 wt % based on the total amount of the heterophasic polypropylene. The amounts of the propylene-based matrix and the dispersed ethylene-α-olefin copolymer may be determined by ¹³C-NMR, as well known in the art. Preferably the ethylene-α-olefin copolymer is an ethylene-propylene copolymer.

The heterophasic polypropylene employed in the present invention can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524.

Preferably, the heterophasic polypropylene is made using Ziegler-Natta catalyst.

The heterophasic polypropylene may be prepared by a process comprising
polymerizing propylene and optionally ethylene and/or α-olefin in the presence of a catalyst system to obtain the propylene-based matrix and
subsequently polymerizing ethylene and α-olefin in the propylene-based matrix in the presence of a catalyst system to obtain the dispersed ethylene-α-olefin copolymer. These steps are preferably performed in different reactors. The catalyst systems for the first step and for the second step may be different or same.

The tensile modulus of the recycled polypropylene (PP1) and of the second polypropylene (PP2) satisfy the following equation:

$$0.6 \leq {TM}_{PP 1} / {TM}_{PP 2} \leq 1.0$$

wherein TM_{PP1} is the tensile modulus of the recycled polypropylene (PP1) as measured according to ISO527-1:2019 using 1A specimen, wherein TM_{PP2} is the MFI of the second polypropylene (PP2) as measured according to ISO527-1:2019 using 1A specimen.

Preferably the tensile modulus of the recycled polypropylene (PP1) and of the second polypropylene (PP2) satisfy the following equation:

$$0.7 \leq {TM}_{PP 1} / {TM}_{PP 2} \leq 0.9$$

wherein TM_{PP1} is the tensile modulus of the recycled polypropylene (PP1) as measured according to ISO527-1:2019 using 1A specimen, wherein TM_{PP2} is the MFI of the second polypropylene (PP2) as measured according to ISO527-1:2019 using 1A specimen.

The melt flow index (MFI) of the recycled polypropylene (PP1) and of the second polypropylene (PP2) satisfy the following equation:

$$0.2 \leq {MFI}_{PP 1} / {MFI}_{PP 2} \leq 1.2$$

wherein MF_{IPP1} is the MFI of the recycled polypropylene (PP1) as measured according to ISO1133-1:2011 at 230°, 2.16 kg, wherein MF_{IPP2} is the MFI of the second polypropylene (PP2) as measured according to ISO1133-1:2011 at 230°, 2.16 kg.

Preferably melt flow index (MFI) of the recycled polypropylene (PP1) and of the second polypropylene (PP2) satisfy the following equation:

$$0. 4 \leq {MFI}_{PP 1} / {MFI}_{PP 2} \leq 1.$$

wherein MF_{IPP1} is the MFI of the recycled polypropylene (PP1) as measured according to ISO1133-1:2011 at 230°, 2.16 kg, wherein MF_{IPP2} is the MFI of the second polypropylene (PP2) as measured according to ISO1133-1:2011 at 230°, 2.16 kg.

Preferably melt flow index (MFI) of the recycled polypropylene (PP1) and of the second polypropylene (PP2) satisfy the following equation:

$$0. 5 \leq {MFI}_{PP 1} / {MFI}_{PP 2} \leq 0.9$$

wherein MF_{IPP1} is the MFI of the recycled polypropylene (PP1) as measured according to ISO1133-1:2011 at 230°, 2.16 kg, wherein MF_{IPP2} is the MFI of the second polypropylene (PP2) as measured according to ISO1133-1:2011 at 230°, 2.16 kg. Without wishing to be bound by theory, an MFI ratio in the preferred range could facilitate the dispersion of the recycled polypropylene (PP1) in the second polypropylene (PP2) during step e) and/or in a further shaping process, e.g. injection molding.

Preferably in the glass fiber reinforced composition obtained in step e), the ratio between the amount of the first polymer composition and the amount of the second polymer composition is in the range from 0.09 to 0.32, more preferably from 0.12 to 0.23, even more preferably from 0.14 to 0.21.

The present invention further relates to a process for preparing an article, comprising the process for the preparation of a glass fiber reinforced composition according to the invention and a step of injection molding the glass fiber reinforced composition obtained in step e) to obtain the article. Preferably the article is an automotive part.

The present invention further relates to a glass fiber reinforced composition obtained by the process for the preparation of a glass fiber reinforced composition according to the invention. The present invention further relates to an article comprising said glass fiber reinforced composition, wherein the article is preferably an automotive part.

The present invention further relates to the use of the process for the preparation of a glass fiber reinforced composition according to the invention for improving the utility of recycled polypropylene.

### Experiments

### Materials

Virgin PP1: SABIC PP 513MNK10E
Virgin PP2: SABIC PP 612MK10EE
PCR1: A recycled polypropylene, Moprylene PC B-420 from Morssikhof-rymoplast
PCR2: A recycled polypropylene, Moprylene PC B-430 from Morssikhof-rymoplast
Wax: Dicera 13082 Paramelt is an impregnating agent according to the invention.
GF: Glass multifilament strand having a diameter D of 19 micron and a tex of 3000 containing 2% by mass of sizing aminosilane agent. GF was provided in continuous form.
Additive package: 20 wt % anti-oxidant B225, 75 wt % coupling agent PO1020, 5 wt % UV stabilizer UV119. The weight percentage is based on the total weight of the additive package.

The properties of Virgin PP1, Virgin PP2, PCR1 and PCR2 are in Table 1:

TABLE 1
Properties of Virgin PP1, Virgin PP2, PCR1 and PCR2

| | Unit/test | Virgin | Virgin | | |
|---|---|---|---|---|---|
| | norm | PP1 | PP2 | PCR1 | PCR2 |
| MFI | g/10 min | 70 | 33 | 20 | 20 |
| | (ISO1133- | | | | |
| | 1: 2011 at | | | | |
| | 230°, | | | | |
| | 2.16 kg) | | | | |
| Tensile | MPa | 1350 | 1450 | 1150 | 1200 |
| modulus | (ISO527- | | | | |
| | 1: 2019 | | | | |
| | using 1A | | | | |
| | specimen) | | | | |
| Density | g/cm3 | 0.905 | 0.905 | 0.92 | 0.905 |
| | (ISO1183- | | | | |
| | 1: 2019) | | | | |
| Ash residue | wt % (ISO | <0.8 | <0.8 | <2.0 | <2.0 |
| | 3451- | | | | |
| | 1: 2019 at | | | | |
| | 550° C.) | | | | |

The measurement norms are also illustrated in Table 1

### Comparative Process

Virgin PP1, Virgin PP2, PCR1 and PCR2 were mixed in a twin screw extruder, the examples obtained in the mixing process were injection molded for tensile measurement according to ISO527-1:2019 using 1A specimen.

The compositions and tensile modulus of Ex1 to 3 are in Table 2

TABLE 2
Compositions and tensile modulus of Ex 1 to 3

| | Ex1 | Ex2 | Ex3 |
|---|---|---|---|
| Virgin PP1 (wt %) | 12.5 | | |
| Virgin PP2 (wt %) | 85.5 | 85.5 | 85.5 |
| PCR1 (wt %) | | 12.5 | |
| PCR2 (wt %) | | | 12.5 |
| Additive package (wt %) | 2 | 2 | 2 |
| Tensile modulus (MPa, ISO527-1: | 1442 | 1418 | 1419 |
| 2019 using 1A specimen) | | | |

By comparison between Ex1 to 3, it is clear that after production from the comparative process, Ex2 and 3 comprising PCR have lower stiffness than Ex1 comprising Virgin PP1.

Ex4, 5 and 6 were prepared in a process comprising the following sequential steps:
a) unwinding from a package the GF which was in continuous form,
b) applying the wax to the GF to form a impregnated GF and
c) applying a thermoplastic composition consisting of Virgin PP1 or PCR1 or PCR2 and additive package as sheath around the impregnated GF to form the sheathed GF,
d) pelletizing the sheathed GF,
e) dry blending the pelletized sheathed GF with Virgin PP2

The examples obtained in step e) were injection molded for tensile measurement according to ISO527-1:2019 using 1A specimen.

The compositions of Ex 4 to 6 are in Table 3

TABLE 3
Compositions and tensile modulus of Ex 4 to 6

| | Ex4 | Ex5 | Ex6 |
|---|---|---|---|
| Virgin PP1 (wt %) | 10 | | |
| Virgin PP2 (wt %) | 67 | 67 | 67 |
| PCR1 (wt %) | | 10 | |
| PCR2 (wt %) | | | 10 |
| GF (wt %) | 20 | 20 | 20 |
| Wax (wt %) | 1.6 | 1.6 | 1.6 |
| Additive package (wt %) | 1.4 | 1.4 | 1.4 |
| Tensile modulus (MPa, ISO527-1: | 3924 | 4572 | 4612 |
| 2019 using 1A specimen) | | | |

By comparison between Ex4 to 6, it is clear that by production in a process according to the invention, Ex5 and 6 comprising PCR surprisingly have higher stiffness than Ex4 comprising Virgin PP1. The information in Table 3 demonstrate that the process according to the invention improves the utility of the recycled polypropylene.

1. A process for the preparation of a glass fiber reinforced composition comprising the sequential steps of:
a) unwinding from a package the continuous glass multifilament strands,
b) applying an impregnating agent to the continuous glass multifilament strands to form the impregnated continuous multifilament strands and
c) applying the sheath of a first polymer composition around the impregnated continuous multifilament strands to form the sheathed continuous multifilament strands,
d) pelletizing the sheathed continuous multifilament strands to form pellets of the sheathed multifilament strands,
e) homogenizing the pellets of the sheathed multifilament strands with a second polymer composition,
wherein the first polymer composition comprises a recycled polypropylene (PP1), wherein the amount of the recycled polypropylene (PP1) is at least 80 wt % based on the total amount of the first polymer composition,
wherein the second polymer composition comprises a second polypropylene (PP2), wherein the amount of the second polypropylene (PP2) is at least 80 wt % based on the total amount of the second polymer composition,
wherein the melt flow index (MFI) of the recycled polypropylene (PP1) and of the second polypropylene (PP2) satisfy the following equation:
$$0.2 \leq {MFI}_{PP 1} / {MFI}_{PP 2} \leq 1.2$$
wherein MF_{IPP1} is the MFI of the recycled polypropylene (PP1) as measured according to ISO1133-1:2011 at 230°, 2.16 kg, wherein MF_{IPP2} is the MFI of the second polypropylene (PP2) as measured according to ISO1133-1:2011 at 230°, 2.16 kg.

2. The process according to claim 1 wherein the tensile modulus of the recycled polypropylene (PP1) and of the second polypropylene (PP2) satisfy the following equation:
$$0.6 \leq {TM}_{PP 1} / {TM}_{PP 2} \leq 1.0$$
wherein TM_{PP1} is the tensile modulus of the recycled polypropylene (PP1) as measured according to ISO527-1:2019 using 1A specimen, wherein TM_{PP2} is the MFI of the second polypropylene (PP2) as measured according to ISO527-1:2019 using 1A specimen.

3. The process according to claim 1 wherein the recycled polypropylene (PP1) has an ash residue of lower than 5.0 wt %, as measured according to ISO 3451-1:2019 at 550° C. based on the total amount of the recycled polypropylene (PP1).

4. The process according to claim 1 wherein the MFI of the recycled polypropylene (PP1) is in the range from 15 to 60 g/10 min, as measured according to ISO1133-1:2011 at 230°, 2.16 kg.

5. The process according to claim 1 wherein the tensile modulus of the recycled polypropylene (PP1) is in the range from 1050 to 1800 MPa, as measured according to ISO527-1:2019 using 1A specimen.

6. The process according to claim 1 wherein step d) comprises two sequential steps:
d1) cooling the sheathed continuous multifilament strands, preferably using water bath, and
d2) cutting the cooled sheathed continuous multifilament strands into pellets of sheathed multifilament strands.

7. The process according to claim 1 wherein the pellets of sheathed multifilament strands are in cylindrical form, wherein the pellets have length in the range from 4 to 25 mm.

8. The process according to claim 1, wherein step e) is carried out by dry blending the pellets of the sheathed multifilament strands with the second polymer composition or by melt mixing the pellets of the sheathed multifilament strands with the second polymer composition.

9. The process according to claim 1 wherein step b) is carried out in a first extruder.

10. The process according to claim 1 wherein step c) is carried out in a second extruder.

11. A process for preparing an article, comprising the process according to claim 1 and a step of injection molding the glass fiber reinforced composition obtained in step e) to obtain the article.

12. The process according to claim 11 wherein the article is an automotive part.

13. A glass fiber reinforced composition obtained by process according to claim 1.

14. An article comprising the glass fiber reinforced composition according to claim 13.

15. (canceled)
